(19) United States
(12) Patent Application Publication
(10) Pub. No.: US 2025/0342352 A1
(43) Pub. Date: Nov. 6, 2025

(54) DIVERSITY BASED DEEP LEARNING SYSTEM

(71) Applicant: North Carolina State University, Raleigh, NC (US)

(72) Inventors: William L. Ditto, Raleigh, NC (US); Anshul CHOUDHARY, Raleigh, NC (US); Anil RADHAKRISHNAN, Raleigh, NC (US); John F. Lindner, Raleigh, NC (US); Kathleen Marie Russell, Wake Forest, NC (US)

(21) Appl. No.: 18/854,170

(22) PCT Filed: Apr. 5, 2023
(86) PCT No.: PCT/US2023/065383

§ 371 Date: Oct. 4, 2024

Related U.S. Application Data
(60) Provisional application No. 63/327,534, filed on Apr. 5, 2022.

(51) Int. Cl. G06N 3/048; G06N 3/0499; G06N 3/0985

(52) U.S. Cl. CPC G06N 3/048; G06N 3/0499; G06N 3/0985

(57) ABSTRACT

Various examples are provided related to diversity based deep learning. In one example, a learned diversity neural network (LDNN) system includes an input layer; an output layer; and at least one hidden layer including at least one activation function neuronal network. The at least one activation function neuronal network includes an input node, an output node, and a plurality of intermediate nodes coupled between the input and output nodes and isolated from other nodes or other activation function neuronal networks of the at least one hidden layer.

### CROSS REFERENCE TO RELATED APPLICATIONS

This application claims priority to, and the benefit of, co-pending U.S. provisional application entitled “Diversity Based Deep Learning System” having Ser. No. 63/327,534, filed Apr. 5, 2022, which is hereby incorporated by reference in its entirety.

### STATEMENT REGARDING FEDERALLY SPONSORED RESEARCH OR DEVELOPMENT

This invention was made with government support under grant number N00014-21-1-2354 awarded by the Office of Naval Research. The government has certain rights in the invention.

### BACKGROUND

Inspired by nature, artificial neural networks are nonlinear systems that can be trained to learn, classify, and predict. Traditionally, artificial neural networks contain identical neurons in each network layer (even if the layers themselves differ).

### SUMMARY

Aspects of the present disclosure are related to diversity based deep learning. In one aspect, among others, a learned diversity neural network (LDNN) system, comprises an input layer; an output layer; and at least one hidden layer comprising at least one activation function neuronal network, the at least one activation function neuronal network comprising an input node, an output node, and a plurality of intermediate nodes coupled between the input and output nodes and isolated from other nodes or other activation function neuronal networks of the at least one hidden layer. Training of the LDNN cab concurrently train the at least one activation function neuronal network to establish an activation function simulated by the trained at least one activation function neuronal network.

In one or more aspects, the at least one hidden layer can comprise a plurality of activation function neuronal networks. Training of the LDNN can concurrently train each of the plurality of activation function neural networks to establish an activation function simulated by that trained activation function neural network, wherein the plurality of trained activation function neural networks comprise a combination of different activation functions. The training of the LDNN can comprise updating inner network parameters based upon inner network loss function gradients and updating sub-network parameters based upon sub-network loss function gradients. The LDNN can be trained using input-output training pairs. A number of the input-output training pairs can be of order 10⁴. A number of training epochs can be of order 10.

In various aspects, each of the at least one activation function neuronal network comprises rectified linear unit (ReLU) neurons, linear neurons, sigmoid neurons, or a combination thereof. The at least one hidden layer can comprise a plurality of activation function neuronal networks. The plurality of activation function neuronal networks can comprise different activation function neuronal networks or the same activation function neuronal network.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a progression from a conventional artificial neural network (top) to a diverse neural network (center) to learned diverse neural network (bottom), in accordance with various embodiments of the present disclosure.

FIGS. 2A and 2B illustrate an example of schematic stochastic gradient descent meta-learning, in accordance with various embodiments of the present disclosure.

FIGS. 3A-3D illustrate examples of meta-learning 2 activations for MNIST-1D classification, in accordance with various embodiments of the present disclosure.

FIGS. 4A-4D illustrate examples of meta-learning 2 activations for nonlinear regression of the van der PoI oscillator, in accordance with various embodiments of the present disclosure.

FIGS. 5A-5C illustrate examples of meta-learning 2 activations for nonlinear regression or forecasting Henon-Heiles orbits, in accordance with various embodiments of the present disclosure.

FIG. 6 illustrates plots the joint probability densities ρ(A, r) for multiple realizations of the learned diversity neural network of FIG. 3 and the homogeneous competitors, in accordance with various embodiments of the present disclosure.

FIG. 7 illustrates examples of mean validation accuracy versus training number after meta-learning two activation functions, in accordance with various embodiments of the present disclosure.

FIG. 8 illustrates an example of neural network MNIST-1D classification accuracy as a function of network size, in accordance with various embodiments of the present disclosure.

FIGS. 9A-9D illustrate examples of meta-learning 3 activations for classification, in accordance with various embodiments of the present disclosure.

FIG. 10 illustrates examples of spectral plots for meta-learning two activation functions for MNIST-1D classification, in accordance with various embodiments of the present disclosure.

FIGS. 11A-11C illustrate examples of learned activation functions for ELU (rectifying), sine (harmonic), tanh (saturating), in accordance with various embodiments of the present disclosure.

FIG. 12 illustrates an example of noisy descent, in accordance with various embodiments of the present disclosure.

FIG. 13 is a schematic block diagram illustrating an example of a system employed for diversity based deep learning, in accordance with various embodiments of the present disclosure.

### DETAILED DESCRIPTION

Disclosed herein are various examples of systems and methods related to diversity based deep learning. Novel artificial neural networks constructed with diverse activation functions in each layer are presented. Rather than hand-craft diversity, gradient meta-learning can be used to find sets of arbitrarily complex activations instantiated by feed-forward neural networks-within-networks. Under training, homogeneous neuronal populations quickly diversify and significantly outperform their homogeneous counterparts on image classification tasks. The results provide examples of the emergence of diversity in artificial neural networks and demonstrate how to leverage diversity to enhance learning. Reference will now be made in detail to the description of the embodiments as illustrated in the drawings, wherein like reference numbers indicate like parts throughout the several views.

Diversity is a hallmark of many complex systems in physics and in physics beyond physics, including microscopic cell populations, marine and terrestrial ecosystems, financial markets, and social networks. In particular, mammalian brains contain billions of neurons with diverse cell types whose complex dynamical patterns are believed responsible for the rich range of cognition, affect, and behavior. But despite the widespread appreciation of diversity in neuroscience, researchers have just begun to explore the role of diversity and adaptability in artificial neural networks.

In this disclosure, neural networks are diversified by varying the neuron types within each layer. The different neurons can be flexibly realized using sub-networks, or networks-within-the-network, which are trained along with the overarching network. This meta-learning generates potent neuron activation function sets, suggestive of orthogonal spanning functions, that increase the expressiveness and accuracy of the network.

How meta-learning diverse activation functions can generate better neural networks, as measured by difficult classification and nonlinear regression tasks, will be described. Neuron participation ratios elucidate the superior potential of heterogeneous neuronal layers over homogeneous layers. Hessian matrix spectra illuminate the geometric nature of optimizing minima. Applications and advantages will be discussed for learned diversity to enhance neural networks, deep learning, and diversity.

Researchers have recently begun to relax the rigid rules that have guided the development and use of artificial neural networks. The computational implications of biophysical diversity and multiple timescales in neurons and synapses for circuit performance have been investigated. Hand-crafted heterogeneous cell types can improve performance of deep neural networks. Diversity in synaptic weights can lead to better generalization in neural networks. Learning combinations of known neuronal activation functions have been considered. Diversity can be constructed by compressing neuronal subspace using determinantal point process. Nesting neural networks inside neural networks have been considered, and the current meta-learning landscape surveyed. The activation function neuronal sub-networks described here can replace units in deep networks to make it closer to how the brain works.

Inspired by natural brains, feed-forward neural networks are nested nonlinear functions of linear combinations of activities:

$${a}^{′} {=}^{vec} δ ( Wa + b ) , \qquad ( 1 )$$

where the activation σ is typically a saturating or rectifying function and training strengthens or weakens the weights and biases W and b to minimize an error or loss function and optimize outputs.

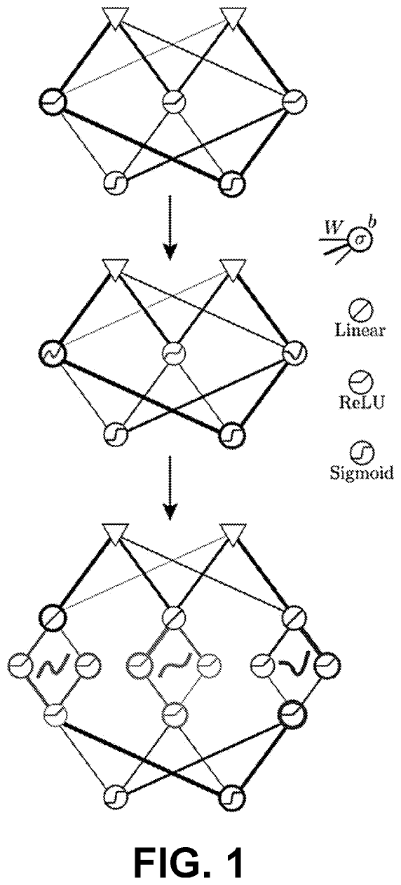

Motivated by the well-studied mammalian visual cortex, varying neuronal activation functions by layer is common. However, within each layer, the activations are typically identical. Neural networks are universal function approximators and are often used to model hypersurfaces, either in nonlinear regression or classification. FIG. 1 illustrates an example of a progression from a conventional artificial neural network (top) to a diverse neural network (center) to learned diverse neural network (bottom). Line thicknesses represent weights W, circle thicknesses represent biases b, and sketches inside circles represent activation functions σ. Information flows top-to-bottom. Training adjusts the weights and biases to optimize the network outputs (top). Multiple activation functions enable diversity within layers (center) and increase the expressiveness of the neural network.

Varying the activations within a layer, as shown in FIG. 1 (center), can increase the expressiveness of the network by providing diverse spanning basis functions. Furthermore, replacing the activations by neural networks, as shown in FIG. 1 (bottom), and training them for optimal results should increase the expressiveness even further. The separate neural networks (bottom) realize these activation functions when training adjusts their weights and biases, perhaps on a different schedule than the originals, to further optimize the network. The training of the activation neural networks can be on a different schedule than the training of the rest of the network, and the activations so obtained can be extracted from the neuronal subnetworks as interpolated functions and efficiently reused in other networks addressing different problems.

As an example of a learned diversity neural network (LDNN), a feed-forward classifier neural network can be constructed whose neurons are sub-networks that modify base activation functions (e.g., zero, identity, sigmoid, or sine functions). The classifier can be trained with many input-output pairs, and the difference between the expected and correct classifications quantified with an error or loss function. The gradient of the loss function can be computed with respect to the classifier's weights and biases, and the loss lowered by shifting its weights and biases down this gradient (inner loop). The gradient of the loss function can be periodically computed with respect to the sub-networks' weights and biases, and the loss further lowered by shifting their weights and biases down this gradient (outer loop). This process can be repeated to improve accuracy.

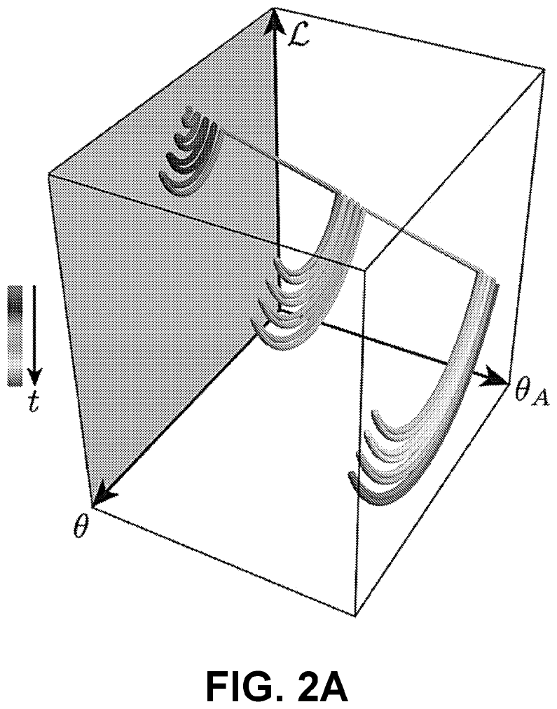

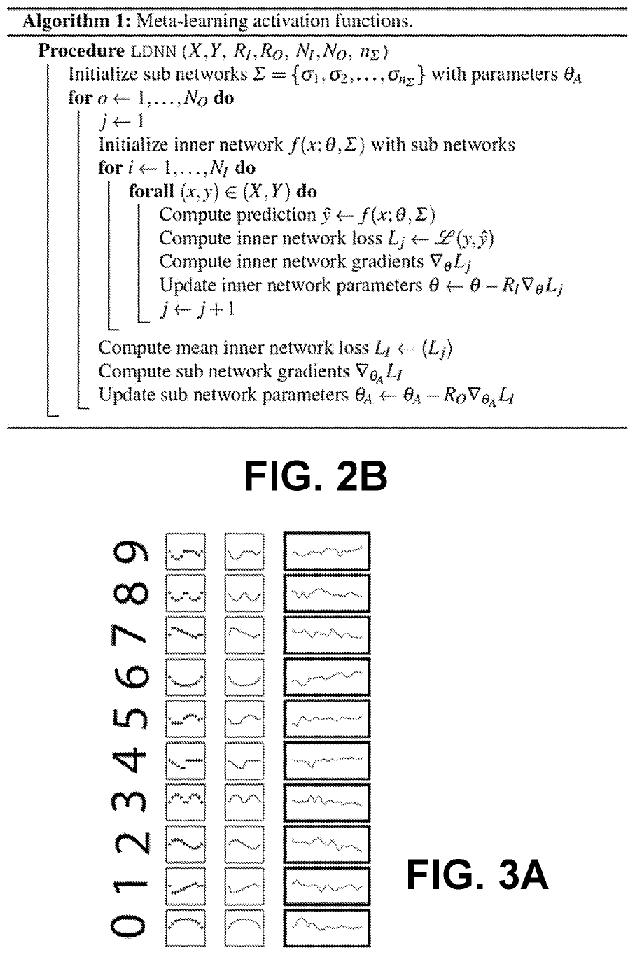

The classifier error or loss [symbol] (θ, θ_{A}, i) depends on the network weights and biases θ, the sub-networks weights and biases θ_{A} that instantiate the activations of hidden-layer neurons, and the inputs i. The randomly shuffled inputs are the stochastic driver that buffets the weights and biases as they adjust to lower losses (during the meta-learning inner loop). Periodically the activation weights and biases open extra dimensions or degrees of freedom to further lower the losses (during the meta-learning outer loop). FIG. 2A illustrates an example of schematic stochastic gradient descent meta-learning. Under randomly shuffled neural-network inputs i, weights and biases θ adjust to lower loss levels [symbol] (θ, θ_{A}, i) (during the meta-learning inner loop), while periodically the activation weights θ_{A} open extra dimensions and themselves adjust to allow even lower loss levels (during the meta-learning outer loop). The color scale codes time t.

The algorithm of FIG. 2B details an example of the meta-learning strategy, where X and Y are batches of inputs and outputs, R are learning rates, N are number of iterations, θ={W, b} are weights and biases, n_{Σ} are number of neuron types, and L are errors or losses. Subscripts I and O indicate inner (or main) and outer (or sub) networks. f(⋅) is the action of the inner network, and [symbol] ⋅ [symbol] is a normalized aggregation. Inner network weights and biases update N_{I}|X| times in the (learner) inner loop, while sub-network weights and biases update N_{O} times in the (meta-learner) outer loop.

Here, learned diversity neural networks are implemented with one hidden layer of 100 neurons and a cross-entropy loss function to classify the MNIST-1D data set, a minimalist variation of the classic Modified National Institute of Standard and Technology digits. Each neuron type in the hidden layer is further instantiated by a feed-forward neural network of 50 hidden units with hyperbolic tangent activation functions. Similar results can be obtained for different numbers of layers and different number of neurons per layer.

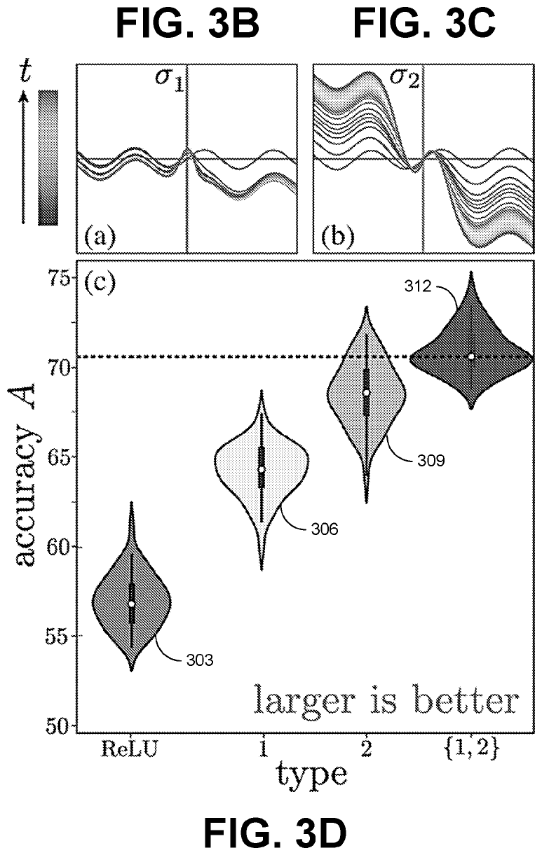

FIGS. 3A-3D illustrate meta-learning 2 activations for MNIST-1D classification. It summarizes meta-learning the activation functions of neurons in the hidden layer subject to the constraint of having two functions distributed equally among the neuronal population. FIG. 3A illustrates an example of MNIST-1D digit construction, rotated 90° to emphasize the one-dimensionality of the digits. FIGS. 3B and 3C show the evolution of two activation functions σₙ(α) from a base sinusoid, with time encoded as the color scale. FIG. 3D shows violin plots summarizes distribution (including median, quartiles, and extent) of validation accuracy A for 50 fully connected neural networks of rectified linear unit (ReLU) neurons (303), type-1 neurons (306), type-2 neurons (309), and a mix of type 1 and type 2 neurons (312). The violin plots demonstrate the validation accuracy for the 50 fully connected neural networks composed of entirely N₁ type neurons (303), entirely N₂ type neurons (306), and mixed type with N₁ and N₂ distributed equally among hidden layer (309). With the same training, the mixed network outperforms either pure network on average. The mix of 2 neuron types out-performs any single neuron type on average. These results are robust with respect to network size.

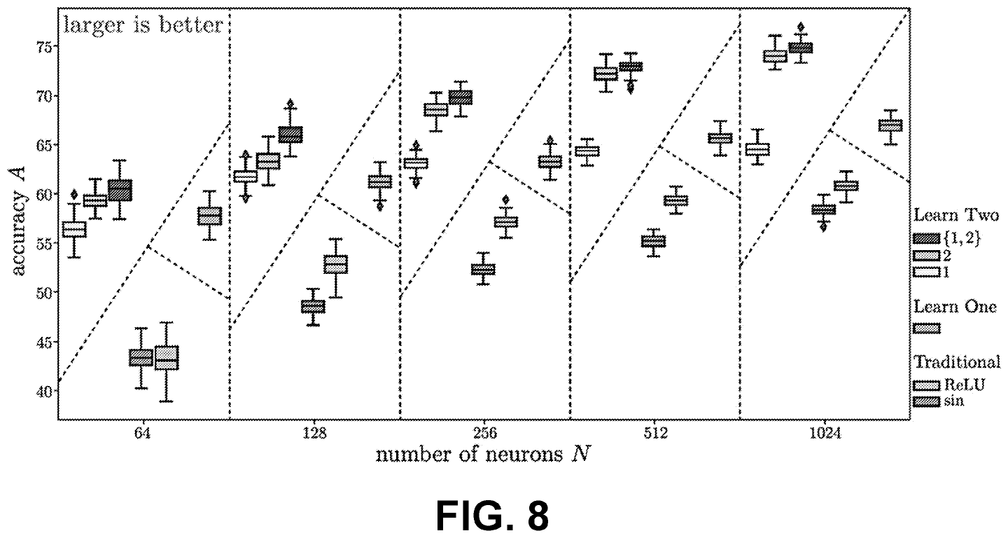

Referring to FIG. 8, illustrated is an example of the neural network MNIST-1D classification accuracy as a function of network size. Box and whiskers plots summarize accuracy distribution (including median, quartiles, extent, and outliers) for 100 initializations. The learning rate can be optimized to avoid over-fitting but is the same for all network sizes. Activation functions evolved from zero (the null function) with similar results evolved from sine. Mixed networks of 2 neuron types outperform pure networks on average for all sizes and outperforms both single learned activation and traditional activations.

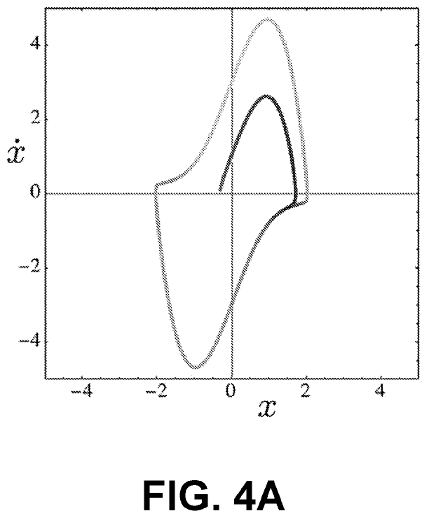

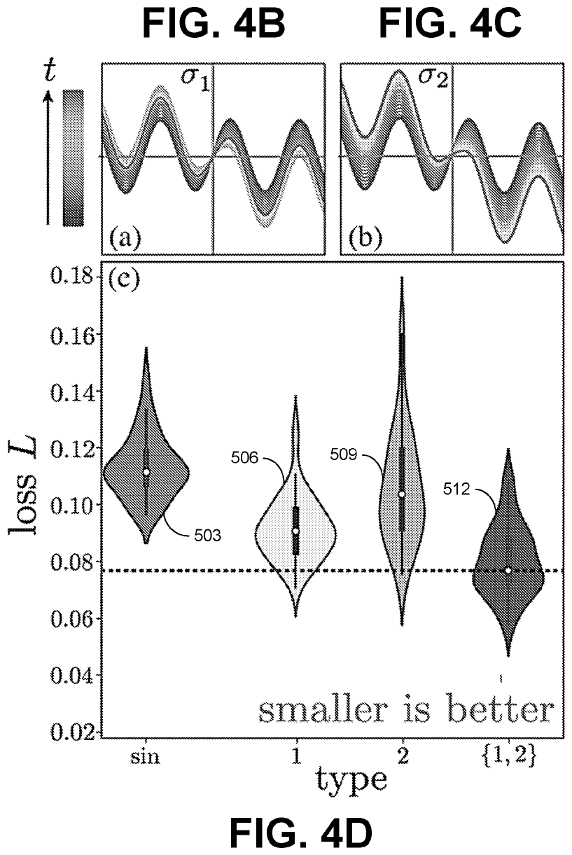

Similar results can be obtained for other tasks, including nonlinear regression of the van der PoI oscillator, which comprise a linear restoring force and a nonlinear viscosity modeled by the differential equation.

$$\ddot{x} - μ ( 1 - {x}^{2} ) \dot{x} + x = 0 , \qquad ( 2 )$$

where the overdots indicate time derivatives. The van der PoI oscillator can model vacuum tubes and heartbeats and can be generalized to model spiky neurons. For viscosity parameter μ=2.7, neural networks were trained to forecast the phase space orbit of the oscillator. FIGS. 4A-4D summarizes meta-learning 2 activations for nonlinear regression of the van der PoI oscillator, with FIG. 4A illustrating an example of a typical orbit attracted to a limit cycle, where the shading encodes time t. FIGS. 4B and 4C show that the activation functions σₙ(a) evolve from a base sinusoid, with a shaded scale encoding time t. FIG. 4D shows violin plots summarize distribution of neural network mean-square error or loss L for 50 fully connected neural networks of sine neurons (503), type-1 neurons (506), type-2 neurons (509), and a mix of type 1 and type 2 neurons (512). On average, the learned diversity neural network outperforms either of its pure components as well as a homogeneous network of neurons with sinusoidal activations. The mix of 2 neuron types outperforms any single neuron type on average.

The paradigmatic Hénon-Heiles Hamiltonian:

$$H = \frac{1}{2} ( {p}_{x}^{2} + {p}_{y}^{2} ) + \frac{1}{2} ( {x}^{2} + {y}^{2} ) + ( {x}^{2} y - \frac{1}{3} {y}^{3} ) \qquad ( 3 )$$

can model a star moving in a galaxy of other stars according to the Hamiltonian flow:

$$\{ \dot{q} , \dot{p} \} = \{ + \frac{\partial H}{\partial p} , - \frac{\partial H}{\partial q} \} , \qquad ( 4 )$$

where q={x, y} and p={pₓ, p_{y}}. Bounded motion is possible in a triangular region of position space. As orbital energy increases, circular symmetry degenerates to triangular symmetry, and integrable motion complexifies to chaotic motion.

Consequently, for this example, activation functions were meta-learned for both a conventional and a Hamiltonian neural network. Unlike conventional neural networks, which learn dynamical systems by intaking position and velocity and outputting their derivatives, a Hamiltonian neural network learns a dynamical system by intaking position and momentum and outputting a single energy-like variable, which it differentiates according to Hamilton's recipe. Rather than learning the derivatives, it learns the Hamiltonian function, which is the generator of derivatives. This more powerful and efficient strategy is an excellent example of physics-informed machine learning.

More specifically, during training a conventional neural network (NN) maps positions and velocities {qₜ, \dot{q}ₜ} to approximations of their time derivatives, and adjusts its internal parameters to minimize the mean-square-error or loss:

$${NN}_{} = {〈 {( {\dot{q}}_{t} - \dot{q} )}^{2} + {( {\ddot{q}}_{t} - \ddot{q} )}^{2} 〉}_{t} . \qquad ( 5 )$$

The trained network can extrapolate a given initial condition via the Euler update {q, \dot{q}}←{q, \dot{q}}+{\dot{q}, \ddot{q}}dt. By contrast, during training a Hamiltonian neural network (HNN) maps position and momenta {qₜ, pₜ} to the scalar Hamiltonian function H, uses reverse-mode automatic differentiation to find the Hamiltonian's gradients, uses the gradients to approximate the position and momentum change rates, and adjusts its internal parameters to minimize the loss:

$${HNN}_{} = {〈 {( {\dot{q}}_{t} - \frac{\partial H}{\partial p} )}^{2} + {( {\dot{p}}_{t} + \frac{\partial H}{\partial q} )}^{2} 〉}_{t} \qquad ( 6 )$$

and enforce Hamilton's motion equations. The trained network can extrapolate a given initial condition via the Euler update {q, p}←{q, p}+{\dot{q}, \dot{q}}dt.

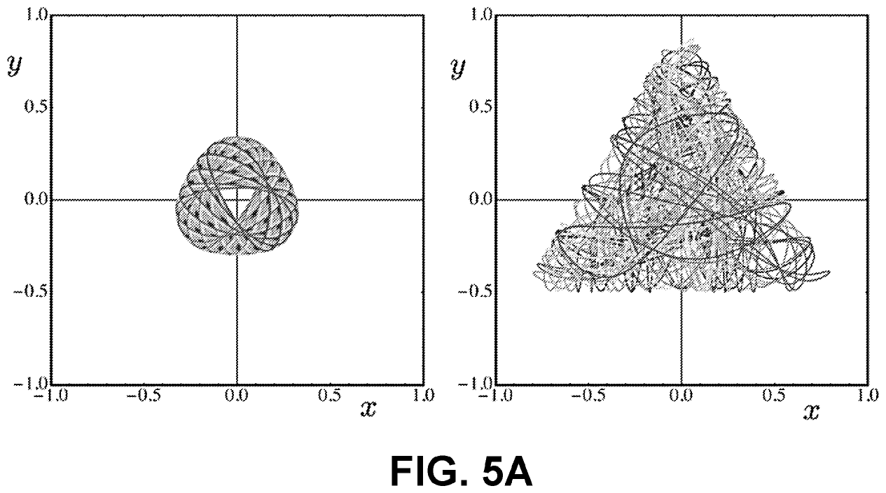

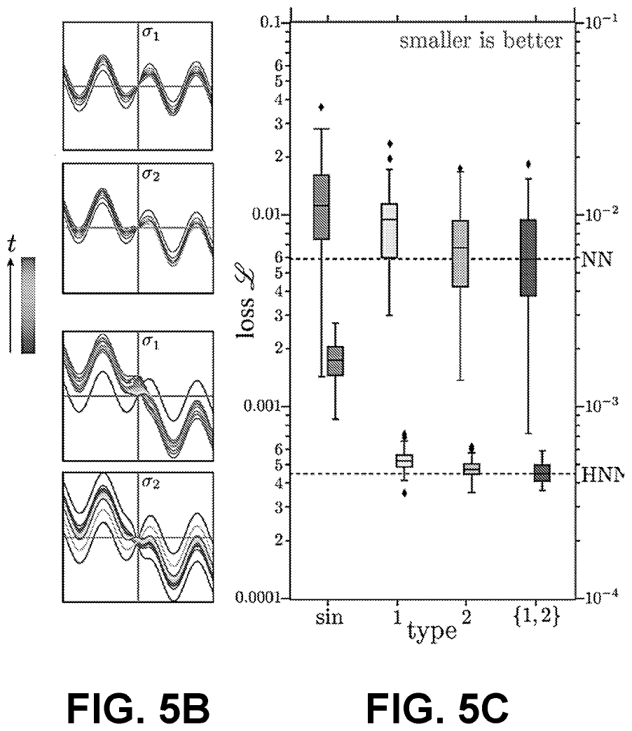

As summarized by FIGS. 5A-5C, illustrate an example of meta-learning 2 activations for nonlinear regressing or forecasting Henon-Heiles orbits. FIG. 5A shows regular and chaotic, low and high-energy Henon-Heiles orbits, where shades code time. FIG. 5B shows conventional and Hamiltonian neural networks learn activation functions from base sinusoids. FIG. 5C shows box plots that summarize distributions of mean-square-error validation losses [symbol] , starting from 50 random initializations of weights and biases, for fully connected neural networks. Hamiltonian neural networks greatly outperform conventional neural networks and heterogeneous neuron types consistently outperform their homogeneous components on average.

The mix of 2 neuron types outperforms any single neuron type on average for both conventional and Hamiltonian neural networks, but the Hamiltonian neural network is much better, and its mixed version is doubly enhanced. Spread in Hamiltonian validation losses is much smaller than the spread in the conventional validation losses, possibly because enforcing symplectic structure on the loss manifold for the Hamiltonian neural network can be a regularization that facilitates more consistent optimization, while the unbounded loss of the conventional neural network suffers greater variance due to the wide range of stable and chaotic trajectories.)

To understand how mixed activation functions outperform homogeneous neuronal populations, the change in the dimensionality of the network activations can be estimated. Start by constructing a neuronal activity data matrix X with N rows corresponding to N neurons in the hidden layer and M columns representing inputs. Each matrix element Xᵢⱼ represents the activity of the i^{th} neuron at the j^{th} input. Center the activity so [symbol] X [symbol] =0. Construct the neural co-variance matrix C=M⁻¹XX^{T}, which indicates how pairs of neurons vary with respect to each other, and compute the participation ratio

$$ℛ = \frac{{( trC )}^{2}}{{trC}^{2}} = \frac{{( {\sum }_{n = 1}^{N} {λ}_{n} )}^{2}}{{\sum }_{n = 1}^{N} {λ}_{n}^{2}} , \qquad ( 7 )$$

where λₙ are the co-variance matrix eigenvalues. If all the variance is in one dimension, say λₙ=δₙ₁, then [symbol] =1; if the variance is evenly distributed across all dimensions, so λₙ=λ₁, then [symbol] =N. Typically, 1< [symbol] <N, and [symbol] corresponds to the number of dimensions needed to explain most of the variance. The normalized participation ratio r= [symbol] /N.

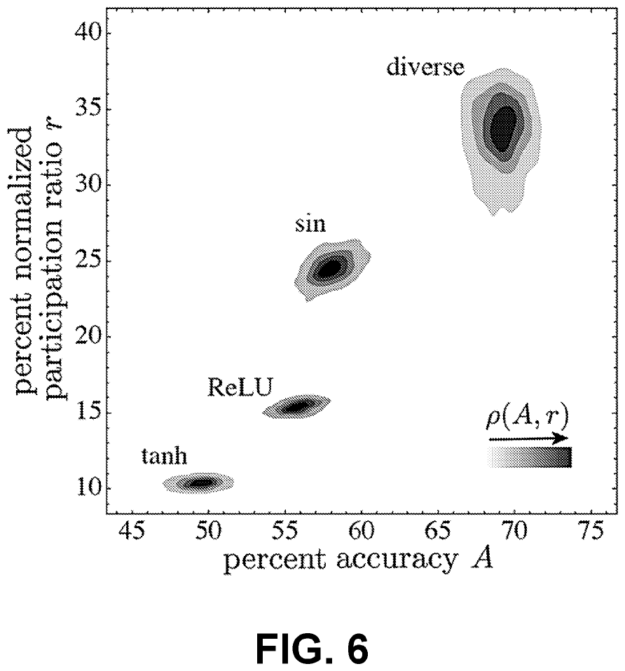

FIG. 6 plots the joint probability densitiesρ(A, r) for multiple realizations of the learned diversity neural network of FIGS. 3A-3D and the homogeneous competitors. The probability densities ρ(A, r) are shown versus accuracy A and normalized participation ratio r=R/N for the multiple realizations of the heterogeneous network and three homogeneous networks with popular activation functions hyperbolic tangent, Rectified Linear Unit f(x)=max (0, x), and sine. Increased participation accompanies increased accuracy, with the diverse network maximizing both. The mix of two neurons types has the best mean accuracy A and normalized participation ratio r, suggesting that more of its neurons are participating when the mix achieves the best MNIST-1D classification. In contrast, homogeneous networks of neurons with popular activation functions have lower accuracy and participation ratios reflecting their poorer effectiveness.

To understand the impact of learned diversity on the geometric nature of loss-function minima, the spectrum of the Hessian matrix H=∇² [symbol] , which captures the curvature of the loss function, can be computed. Since, H is a symmetric matrix, all its eigenvalues are real. A purely convex loss function would have a positive semi-definite Hessian everywhere. However, in practice, the loss function is almost always non-convex (with multiple spurious minima) due to the presence of permutation symmetries of the hidden neurons. Therefore, understanding how diversity helps training find deeper minima is important.

Previous work suggests that flatter minima generalizes better to the unseen data. For the neural network meta-learning two neuronal activation functions of FIG. 1, it was found that once training has converged, the resulting minima from the diverse neurons is flatter than from homogeneous ones, as measured by both the trace TrH of the Hessian and the fraction f of its eigenvalues near zero: TrH₁>TrH₂>TrH₁₂ and f₁<f₂<f₁₂. If steep minima are harder for gradient descent to locate, then the flatter minima engineered and discovered by learned diversity neural networks offer enhanced optimization.

Biomimetic engineering or biomimicry is design inspired by nature. Just as monoculture crops can be fragile, while diverse crops can be robust, heterogeneous neural networks can outperform homogeneous ones. Here, advantages of varying activation functions within each layer are highlighted and the best variation by replacing activations by sub-networks can be learned.

Conceptually, learned diversity neural networks can discover novel sets of activation functions, when most artificial neural networks use just one of a small number of conventional activations per layer. Practically, mixes of learned activations can outperform traditional activations-where even a 1% improvement can be significant-and the learned activations can be efficiently reused in diverse neural networks. The learned diversity may be optimized by adjusting hyperparameters, applying learned diversity to a wider range of regression and classification problems, testing diverse neural networks for robustness, investigating clustering of learned activations, and applying learned diversity to different neural network architectures, such as recurrent neural networks and reservoir computers, as well as physics-applied and physics-informed neural networks.

Learned diversity offers neural networks sets of tailored basis functions, which enhance their expressiveness and adaptability and facilitates efficient function approximation. When given the ability to learn their neuronal activation functions, neural networks discover heterogeneous arrangements of nonlinear neuronal activations that can outperform their homogeneous counterparts with the same training. Specific examples of dynamical systems that spontaneously select diversity over uniformity are provided, and thereby furthers the understanding of diversity and its role in strengthening natural and artificial systems.

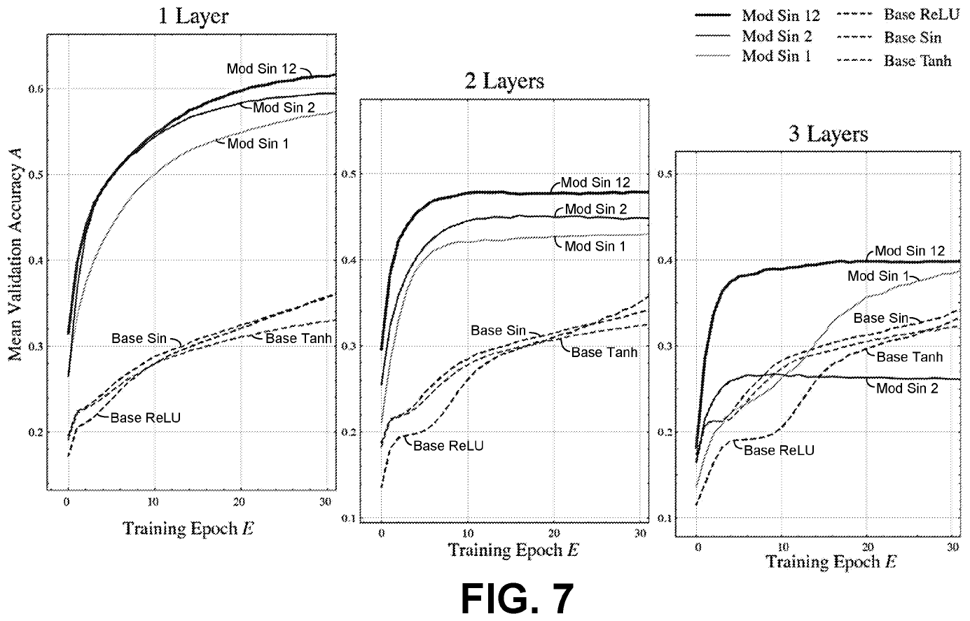

Multiple Layers. Learned diversity was explored using both multiple hidden layers in the classifying neural network and multiple hidden layers in the neuronal sub-networks with similar results. FIG. 7 illustrates examples of mean validation accuracy versus training number (number of training data) in epochs after meta-learning two activation functions based on a sinusoid using networks of 1, 2, 3 hidden layers. In this example, the heterogeneous network (Mod Sin 12) outperforms both homogeneous networks of either component (Mod Sin 1 and Mod Sin 2) and homogeneous networks using popular activation functions (Base ReLU, Base Sin and Base Tanh) on average.

Hyperparameters are the same in each case, with no attempt to optimize for additional layers. Accuracies are modest due to the small network sizes and the inherent difficulty of classifying MNIST-1D digits, which is challenging even for humans, but the modest accuracies allow us to clearly illustrate the learned diversity improvements.

For 1 hidden layer, the meta-learning inner loop trained a 40:100:10 fully-connected feed-forward neural network with 10⁴ 40-pixel classified digit images shuffled 5 times while the meta-learning outer loop updated the weights and biases of the 2-activation-function 1:50:1 sub-networks 10³ times, resetting the inner network every time, and similarly for multiple hidden layers.

Neuron Number Details. As previously discussed, learned diversity has been explored by systematically varying the number of hidden-layer neurons in the neural networks. FIG. 8 illustrates an example of neural network MNIST-1D classification accuracy as a function of network size. Box and whiskers plots summarize accuracy distribution (including median, quartiles, extent, and outliers). The same learning rate was used for each network size, optimized to avoid over-fitting. The learned activation functions were manually fitted, and evolved from, for each of the configurations. The activation functions evolved from zero (the null function) with similar results evolved from sine. They were run for 15 epochs for 100 different realizations and computed their classification accuracies. For all sizes, the mixed networks of 2 neuron types outperform the pure networks on average, and also outperform both a learned single activation function and traditional activation functions like ReLU and sine.

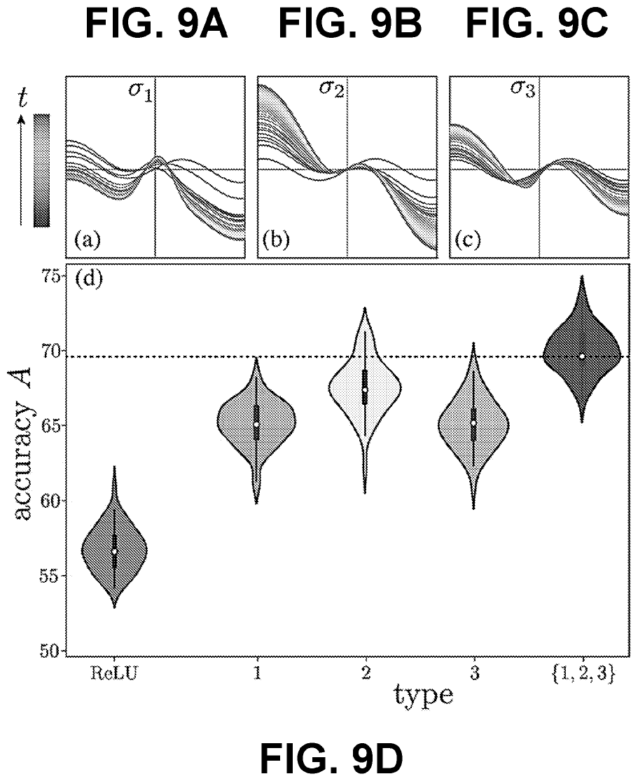

Meta-Learning 3 Activations. FIGS. 9A-9D summarize meta-learning 3 activations for classification. The activation functions of neurons are subject to the constraint of having three functions distributed equally among the neuronal population for the MNIST-1D classification task. The meta-learning generates roughly three classes of activations from its sinusoidal (or other) start, typically symmetric or anti-symmetric near the origin, providing a kind of spanning basis, as orthogonal as possible. FIGS. 9A-9C show how the activation functions on (a) evolve from a base sinusoid, with encoding over time t. FIG. 9D shows violin plots summarizing validation accuracy A for 50 fully connected neural networks of type-1 neurons, type-2 neurons, type-3 neurons, and a mix of all 3 neuron types (1,2,3). Again, the mixed network outperforms the three pure networks on average.

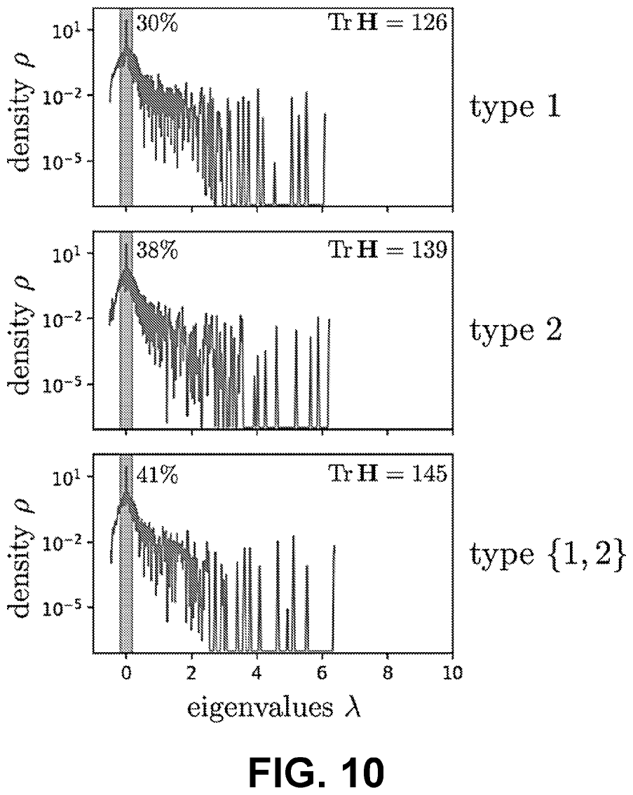

Hessian Details. To understand the impact of learned diversity on the geometric nature of the loss function minima, the spectrum of the Hessian matrix H=∇² [symbol] , which measures the loss function curvature, was computed. FIG. 10 shows spectral plots for meta-learning two activation functions for MNIST-1D classification. Spectral density ρ versus eigenvalues λ of the loss-function second-derivative hessian matrices for classifying MNIST-1D with pure and mixed networks display clear trends in both traces and area bounded near zero. The fraction of bounded area in the shaded region is a measure of the flatness of a minimum, as is the hessian trace, both of which trend similarly.

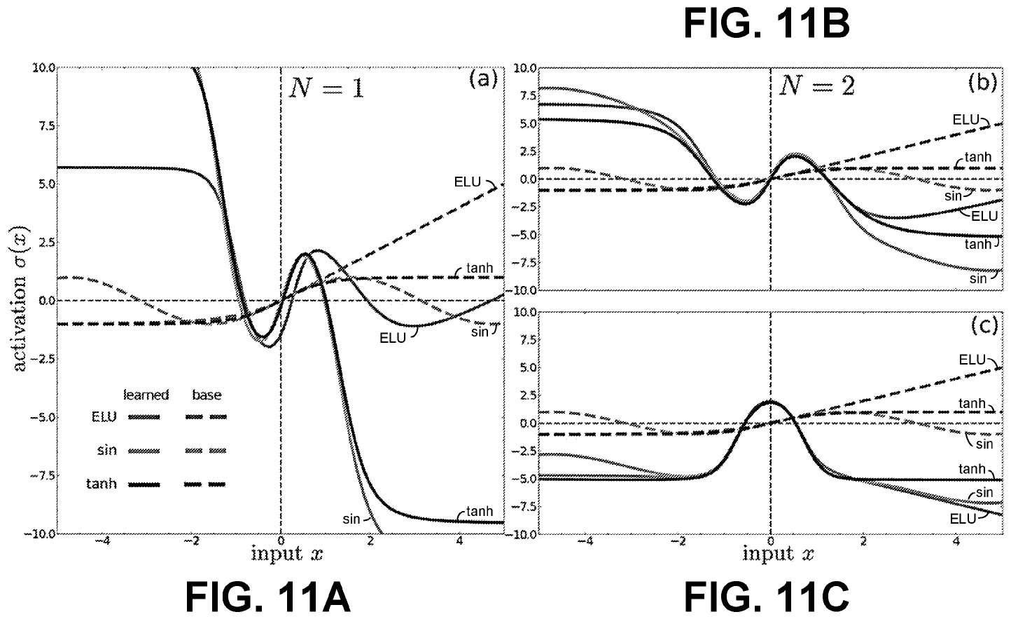

Universality of Learned Activations. Learned activation functions appear qualitatively independent of the base activation function/FIGS. 11A-11C illustrate learned activation functions for ELU (rectifying), sine (harmonic), tanh (saturating), respectively. As shown, the learned activation functions σ(x) based on rectifying ELU(x), harmonic sin(x), and saturating tanh (x) have qualitatively similar near-zero behavior. In FIG. 11A, a single function is learned that behaves as an odd function near zero. When allowed to learn two activations, as in FIGS. 11B and 11C, odd and even functions are learned starting from many base functions.

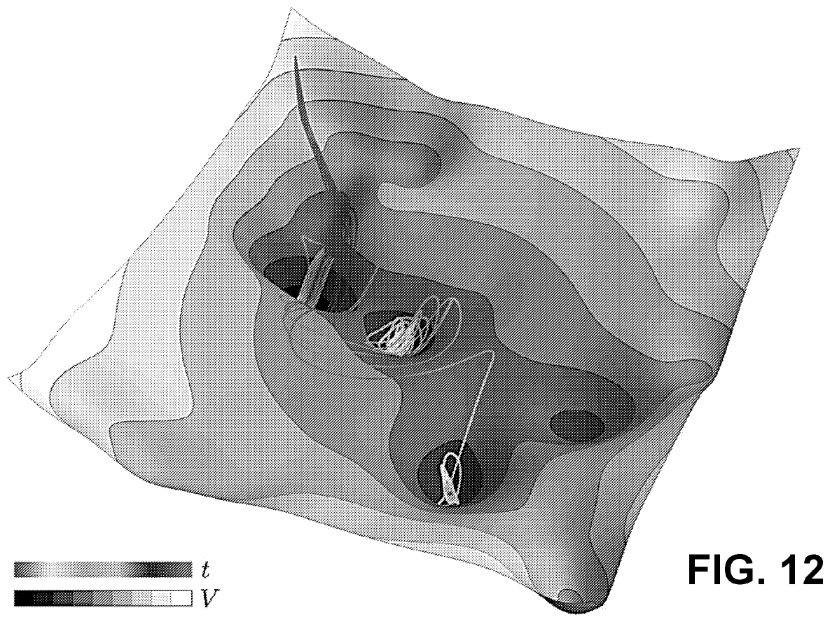

Stochastic Processes Insights. Optimizing a neural network by randomly shuffling training data is like a noisy descent to a minimum in a potential landscape. The landscape is the network's error or loss as a function of its weights and biases, and its shape depends on the neuron activation functions. FIG. 12 illustrates an example of noisy descent. The plot codes time t as the state point wanders to different local minima of potential landscape V from same initial conditions under multiple realizations of the same noise. The effective dynamics is that of an overdamped particle buffeted by noise sliding on a complicated potential with many local minima. The Langevin equation:

$$d {θ}_{t} = - ∇ ℒ ( {θ}_{t} ) dt + \sqrt{2 D} \cdot d {𝒲}_{t} \qquad ( 8 )$$

with noise intensity D=η [symbol] (θ)H(θ)/B describes the evolution of the weights and biases θ={Wᵢⱼ, bᵢ} in a valley with local minimum θ*, where η is the learning rate and B is the training batch size. The drift term dt includes minus the gradient of the loss function [symbol] , and the Brownian motion noise term dWₜ includes the learning rate η. The noise aligns with the Hessian near a minimum, and the equation (8) Hessian dependence ensures that stochastic gradient descent escapes multiple sharp minima via directions corresponding to large eigenvalues of the Hessian and eventually converges to the flatter minimum.

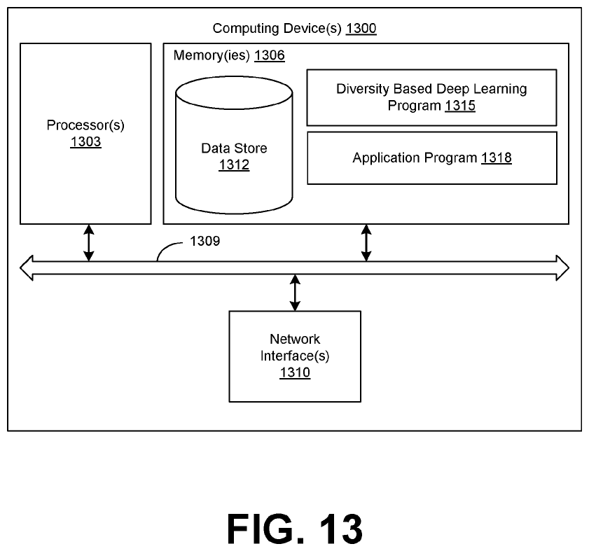

Computer Implementation. The neural networks were implemented in the Python programming language using the PyTorch open source machine learning library. The code for the analysis and the network implementation in PyTorch can be found at the GitHub repository. FIG. 13 illustrates an example of a computing (or processing) device that can be utilized for diversity based deep learning using the described techniques.

Gradient Based Metalearning. The learner-meta-learner structure of the metalearning algorithm brings with it significant computational costs. The implementation of the algorithm was constrained on the number of learner/inner loops within the metalearner/outer loops (iterations) since the inner loop was held in memory for the outer loop computation and optimization. In fact, this is a limitation of the gradient based meta-learning algorithm that limits the horizon of meta-objective function. Number of training pairs is of order 10⁴, and number of training epochs is of order 10. Due to computational constraints, the number of inner iterations is much smaller than the number of outer iterations.

Hessian Computation. PyHessian Library was used to compute hessian based statistics without the cost of generating the full hessian matrix. The trace of the hessian matrix was computed using Hutchinson's method exploiting the symmetric nature of the matrix. The Empirical Spectral Density (ESD) of hessian eigenvalues was computed through Stochastic Lanczos Quadrature (SLQ) within several successive approximation schemes. At an implementation level, a classifier using the learned activation(s) was trained in Pytorch and the model was saved. Using this saved model and test data, PyHessian can use PyTorch's backward graph to compute the gradients needed to build the hessian trace and ESD.

Interpolation and Fitting. The activation function was captured after metalearning as the output of the learned activation networks on the interval [−10, 10] with 100 linearly spaced points. This output was then linearly interpolated between points and used as the activation function for the classifier at validation. Quadratic or cubic splines or symbolic regression can also be used. High order (>10) polynomials need to fit the activation curves accurately so, while possible, polynomials are not recommended as a reliable way to capture the features of the learned activation function.

With reference to FIG. 13, shown is a schematic block diagram of a computing (or processing) device 1300 that can be utilized for diversity based deep learning using the described techniques. In some embodiments, among others, the computing device 1300 may represent a mobile device (e.g., a smartphone, tablet, computer, etc.) or other processing device. Each computing device 1300 includes processing circuitry comprising at least one processor circuit, for example, having a processor 1303 and a memory 1306, both of which are coupled to a local interface 1309. To this end, each computing device 1300 may comprise, for example, at least one server computer or like device. The local interface 1309 may comprise, for example, a data bus with an accompanying address/control bus or other bus structure as can be appreciated.

In some embodiments, the computing device 1300 can include one or more network interfaces 1310. The network interface 1310 may comprise, for example, a wireless transmitter, a wireless transceiver, and a wireless receiver. As discussed above, the network interface 1310 can communicate to a remote computing device using a Bluetooth protocol. As one skilled in the art can appreciate, other wireless protocols may be used in the various embodiments of the present disclosure.

Stored in the memory 1306 are both data and several components that are executable by the processor 1303. In particular, stored in the memory 1306 and executable by the processor 1303 are diversity based deep learning program 1315, application program 1318, and potentially other applications. Also stored in the memory 1306 may be a data store 1312 and other data. In addition, an operating system may be stored in the memory 1306 and executable by the processor 1303.

It is understood that there may be other applications that are stored in the memory 1306 and are executable by the processor 1303 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1306 and are executable by the processor 1303. In this respect, the term “executable” means a program file that is in a form that can ultimately be run by the processor 1303. Examples of executable programs may be, for example, a compiled program that can be translated into machine code in a format that can be loaded into a random access portion of the memory 1306 and run by the processor 1303, source code that may be expressed in proper format such as object code that is capable of being loaded into a random access portion of the memory 1306 and executed by the processor 1303, or source code that may be interpreted by another executable program to generate instructions in a random access portion of the memory 1306 to be executed by the processor 1303, etc. An executable program may be stored in any portion or component of the memory 1306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1306 is defined herein as including both volatile and nonvolatile memory and data storage components. Volatile components are those that do not retain data values upon loss of power. Nonvolatile components are those that retain data upon a loss of power. Thus, the memory 1306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1303 may represent multiple processors 1303 and/or multiple processor cores and the memory 1306 may represent multiple memories 1306 that operate in parallel processing circuits, respectively. In such a case, the local interface 1309 may be an appropriate network that facilitates communication between any two of the multiple processors 1303, between any processor 1303 and any of the memories 1306, or between any two of the memories 1306, etc. The local interface 1309 may comprise additional systems designed to coordinate this communication, including, for example, performing load balancing. The processor 1303 may be of electrical or of some other available construction.

Although the diversity based deep learning program 1315 and the application program 1318, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the diversity based deep learning program 1315 and the application program 1318, that comprises software or code can be embodied in any non-transitory computer-readable medium for use by or in connection with an instruction execution system such as, for example, a processor 1303 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the diversity based deep learning program 1315 and the application program 1318, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1300, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A learned diversity neural network (LDNN) system, comprising:
an input layer;
an output layer; and
at least one hidden layer comprising at least one activation function neuronal network, the at least one activation function neuronal network comprising an input node, an output node, and a plurality of intermediate nodes coupled between the input and output nodes and isolated from other nodes or other activation function neuronal networks of the at least one hidden layer.

2. The LDNN system of claim 1, wherein training of the LDNN concurrently trains the at least one activation function neuronal network to establish an activation function simulated by the trained at least one activation function neuronal network.

3. The LDNN system of claim 2, wherein the at least one hidden layer comprises a plurality of activation function neuronal networks.

4. The LDNN system of claim 3, wherein training of the LDNN concurrently trains each of the plurality of activation function neural networks to establish an activation function simulated by that trained activation function neural network, wherein the plurality of trained activation function neural networks comprise a combination of different activation functions.

5. The LDNN system of claim 2, wherein the training of the LDNN comprises updating inner network parameters based upon inner network loss function gradients and updating sub-network parameters based upon sub-network loss function gradients.

6. The LDNN system of claim of claim 5, wherein the LDNN is trained using input-output training pairs.

7. The LDNN system of claim 6, wherein a number of the input-output training pairs is of order 10⁴.

8. The LDNN system of claim 5, wherein a number of training epochs is of order 10.

9. The LDNN system of claim 1, wherein each of the at least one activation function neuronal network comprises rectified linear unit (ReLU) neurons, linear neurons, sigmoid neurons, or a combination thereof.

10. The LDNN system of claim 9, wherein the at least one hidden layer comprises a plurality of activation function neuronal networks comprising different activation function neuronal networks.
